(19) United States
(12) Patent Application Publication
(10) Pub. No.: US 2023/0280770 A1
(43) Pub. Date: Sep. 7, 2023

(54) DEVICE FOR PROVIDING A FLUID AND SANITARY FITTING SYSTEM

(71) Applicant: BLANCO GMBH + CO KG, Oberderdingen (DE)

(72) Inventors: Michael KREBS, Maxdorf (DE); Thomas ZÖLLNER, Wuppertal (DE)

(73) Assignee: BLANCO GMBH + CO KG, Oberderdingen (DE)

(21) Appl. No.: 18/115,884

(22) Filed: Mar. 1, 2023

(30) Foreign Application Priority Data
Mar. 2, 2022 (DE) 10 2022 202 151.7

(51) Int. Cl. G05D 23/13

(52) U.S. Cl. CPC G05D 23/1333; G05D 23/1366

(57) ABSTRACT

The invention relates to a device for providing a fluid, in particular water, comprising a central supply device of warm fluid, preferably comprising a central heating system, for providing warm fluid, a supply device of cold fluid for supplying cold fluid, a local supply device of hot fluid, characterized in that a control device is arranged, which is designed to control the devices, in such a way that, below a warm fluid output quantity and/or below a temperature at at least one point of a warm-fluid supply line from the supply device of warm fluid to an outlet, the warm fluid is provided by admixing hot fluid, and above the predeterminable tapped warm-fluid quantity and/or temperature at at least one point of a warm-fluid supply line, the warm fluid is provided by the central supply device of warm fluid.

The invention relates to a device for providing a fluid, in particular water, comprising a central supply device of warm fluid, preferably comprising a central heater, for providing warm fluid, a supply device of cold fluid for providing cold fluid, and a local hot-fluid supply device.

The invention further relates to a method of providing a fluid, in particular water, comprising the steps:
providing warm fluid by means of a central supply device of warm fluid, preferably comprising a central heating system,
providing cold fluid by means of a supply device of cold fluid for providing cold fluid, and
providing hot fluid by means of a local hot-fluid-supply device.

The invention further relates to a sanitary fitting system comprising a device for providing a fluid and a sanitary fitting connected in a fluidic manner to the device for providing the fluid.

Although generally applicable to any device for providing a fluid, this invention will be explained with reference to a sanitary fitting as a device for providing a fluid.

Although generally applicable to any fluids, this invention is described with reference to water as a fluid.

Sanitary fittings have become known in a variety of ways. Known sanitary fittings have, for instance, a fitting body having at least one actuator for setting at least one characteristic of a fluid flow routed through the sanitary fitting. The property may be, for instance, the flow rate of the fluid flow or the temperature of the fluid flow. In known sanitary fittings, for instance, the fluid flow is mixed from a separate cold-water flow and warm -water flow by means of a mixing device, and from there it is routed to a discharge.

To increase functionality, for instance, a sanitary fitting has become known from DE 10 2013 000 773 A1 or DE 10 2013 002 236 A1 having at least one first control element for setting the temperature and/or quantity of mixed water and having at least one second control element for setting the quantity of hot water. Typically, this involves providing mixed warm and cold water, wherein the warm water is provided by a central warm-water source, such as a central heating system. Hot water is usually not provided by the central warm-water source, but by a boiler that can provide hot water of temperatures above 60° C.

Because the central warm-water source is regularly located far away from the relevant sanitary fitting, the warm water provided by the central warm-water source cools down significantly due to the length of the pipe, for instance in some cases more than 10 m, up to the dispensing point, the sanitary fitting. If warm water is tapped after a longer period of time, initially only cold water is dispensed until new warm water is routed through the entire line to the outlet due to the length of the line.

The disadvantage thereof is that the cold water is wasted. In addition, to heat cold water to provide warm water, the central warm water source typically must first be heated itself, which requires a large amount of energy, even if only small amounts of warm water are tapped.

To reduce the amount of unused water, it has become known, for instance, from DE 10 2014 004 559 A1, to provide a reheater along the warm water line. A process for providing mixed water has become known From DE 10 2015 000 015 A1, in which the fluid flow, when it falls below a certain temperature, is returned to a storage tank.

The disadvantage thereof is the costly design, in particular due to an additional heating device and additional lines, and the costly but inflexible control system.

Therefore, this invention addresses the problem of providing a device for providing a fluid and a sanitary fitting system, which result in reduced fluid and energy consumption and at the same time provide for a high degree of flexibility.

This invention further addresses the problem of providing a method for providing a fluid, which results in reduced fluid and energy consumption and at the same time provides great flexibility.

This invention further addresses the problem of providing an alternative device for providing a fluid, an alternative sanitary fitting system and an alternative process for providing a fluid.

This invention solves the problems mentioned above for a device for providing a fluid, in particular water, comprising
a central supply device of warm fluid, preferably comprising a central heating system, for providing warm fluid,
a supply device of cold fluid for supplying cold fluid,
a local supply device of hot fluid,
   in that a control device is arranged, which is designed to control the devices in such a way that, below a warm-fluid output quantity and/or below a temperature at at least one point of a warm-fluid supply line from the supply device of warm fluid to an outlet, the warm fluid is provided by admixing hot fluid, and above the predeterminable tapped warm-fluid quantity and/or temperature at at least one point of a warm-fluid supply line, the warm fluid is provided by the central supply device of warm fluid.

This invention solves the problems mentioned above using a method for providing a fluid, in particular water, comprising the steps:
providing warm fluid by means of a central supply device of warm fluid, preferably comprising a central heating system,
providing cold fluid by means of a supply device of cold fluid for providing cold fluid,
providing hot fluid by means of a local hot-fluid-supply device,
   in that below a predeterminable output quantity of warm fluid and/or below a temperature, at at least one point of a warm-fluid supply line from the supply device of warm fluid to an outlet, the warm fluid is supplied by admixing hot fluid, and above the pre-determinable output quantity of warm fluid and/or temperature at at least one location of a warm-fluid supply line, the warm fluid is supplied by the central supply device of warm fluid.

This invention also solves the problems mentioned above using a sanitary fitting system comprising a device for providing a fluid according to any of the claims 1-7, and a sanitary fitting connected in a fluidic manner to the device for providing the fluid.

The term “sanitary” shall be understood in the broadest sense and refers, in particular in the claims, preferably in the description, generally to the kitchen area, the bathroom or laundry area, and the heating area.

The term “fluid” shall be understood in the broadest sense and, particularly in the claims, preferably in the description, refers generally to one or more liquids, one or more gases, and mixtures thereof, in particular of gases dissolved in a liquid.

The term “central” with respect to a supply device of warm fluid shall be understood in the broadest sense and, in particular in the claims, preferably in the description, refers generally to a supply device of warm fluid centrally arranged in a house, for instance a single-family home, such as a central heating system, a central warm-water storage tank or to a circulating water heater, also called a combination boiler, for an apartment or the like, which in particular supplies warm water to a plurality of very different dispensing points within the house or within an apartment.

The term “local” with respect to a hot-fluid supply device shall be understood in the broadest sense and refers, in particular in the claims, preferably in the description, generally to a hot-fluid supply device arranged locally or decentrally in a house, for instance in a single-family home, such as an instantaneous water heater, boiler or the like, which in particular provides hot water for only one dispensing point directly connected thereto within the house. There, the line length between the hot-fluid supply device and the dispensing point is less than 5 m, preferably less than 2 m, in particular less than 1.5 m, preferably less than 1 m.

An advantage achieved in that way is that it significantly reduces the amount of insufficiently heated warm fluid, in particular warm water. In addition, user satisfaction is improved because sufficient amounts of warm fluid are available almost immediately after warm fluid is dispensed. In addition, an advantage is that the energy requirement is reduced, because a central supply device of warm fluid does not have to be operated for smaller output quantities.

Further features, advantages and further embodiments of the invention are described below or may be disclosed in that way.

According to a preferred embodiment of the invention, a desired quantity of warm fluid can be set by means of a setting device, wherein the control device is designed to check whether the desired warm-fluid quantity is greater or lesser than the predeterminable hot-fluid-output quantity. The advantage thereof is that a certain tapped quantity of fluid can be set in advance by a user and dispensed later. In a particularly energy-efficient manner, the control device can then dispense the warm fluid either by means of the central supply device of warm fluid, if the tapped quantity is greater than the presettable output quantity of warm fluid, or by means of admixing hot fluid, if it is smaller.

According to a further preferred embodiment of the invention, the setting device has a mechanical operating element, an optical detection element and/or a radio interface for setting the desired quantity of warm fluid. The advantage is a simple and flexible setting of the desired quantity of warm fluid by a user.

According to a further preferred embodiment of the invention, the control device and/or the setting device comprise(s) a computing device, which computes an output quantity of warm fluid on the basis of a tapping period, a measured value of a fluid volume flow and/or a predeterminable value of the fluid volume flow. The advantage thereof is that warm fluid can be dispensed for a user in an energy-efficient manner without the user having to first select a quantity of warm fluid to be dispensed based on a preselection.

According to another preferred embodiment of the invention, at least one temperature sensor for measuring the temperature is arranged at at least one point downstream of the supply device of warm fluid. The advantage thereof is that it enables an accurate measurement of the temperature of the warm fluid in the lines, i.e., appropriately metered quantities of warm fluid can then be added efficiently.

According to a further preferred embodiment of the invention, the warm-fluid supply line and hot-fluid supply line can be connected to each other via at least one switchable valve. This makes it particularly easy to add hot fluid to the warm fluid in a controlled manner.

According to another preferred embodiment of the invention, the setting device comprises a user interface for actuating the heating of the supply device of hot fluid. In this way, hot fluid is only provided by the supply device of hot fluid as needed by a user when it is needed. In this way, any unnecessary heating of the hot fluid and thus unnecessary energy consumption is prevented.

In accordance with a preferred embodiment of the invention, a user interface is used to set the predeterminable output quantity of warm fluid and an output of the fluid is initiated. An advantage achieved in this way this is that it allows a user to flexibly pre-select a desired output quantity of warm fluid.

According to another preferred embodiment of the invention, a heating device for the supply device of hot fluid is actuated by means of a user interface. In this way, hot fluid is only provided by the supply device of hot fluid as needed by a user when it is needed. In this way, unnecessary heating of the hot fluid is prevented.

According to a further preferred embodiment of the invention, a warm-fluid withdrawal quantity is computed on the basis of a determined magnitude of a volume flow of the discharged fluid and/or on the basis of specifications for the volume flow and/or on the basis of a withdrawal period of the discharged fluid, this is compared to the predeterminable output quantity of warm fluid and the warm fluid is output in accordance with the comparison. An advantage achieved is that warm fluid is dispensed in an energy efficient manner, without direct preselection of the output quantity of warm fluid by a user.

Further important features and advantages of the invention are described in more detail in the dependent claims, in the drawing, and in the accompanying figure description based on the drawing.

It goes without saying that the features mentioned above and those to be explained below can be used not only in the combination indicated in each case, but also in other combinations or on their own, without departing from the scope of this invention.

Preferred embodiments and embodiments of this invention are shown in the drawings and will be explained in more detail in the description below, wherein identical reference numerals refer to identical or similar or functionally identical components or elements.

In schematic form

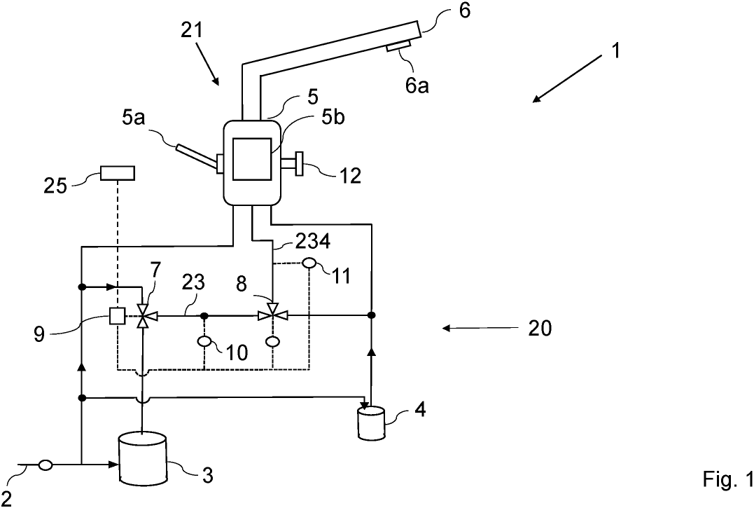

FIG. 1 shows a sanitary fitting according to an embodiment of this invention; and

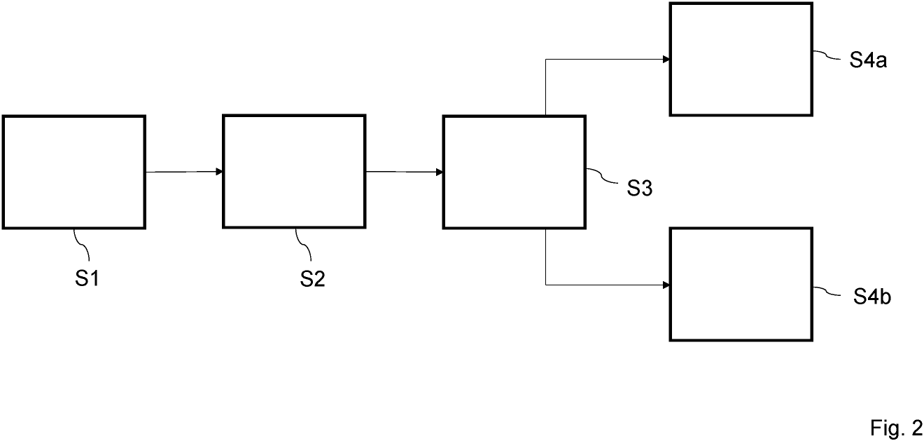

FIG. 2 shows steps of a method according to an embodiment of this invention.

FIG. 1 shows a sanitary fitting system according to an embodiment of this invention.

In detail, FIG. 1 shows a sanitary fitting system 1 that includes a cold-water supply line 2, a central heating system with warm-water supply 3, a boiler 4, and a sanitary fitting 21 for dispensing cold, warm, and hot water. Here, the sanitary fitting 21 has a base body 5 with a mixing device 5b, on which a lever 5a is arranged for setting the flow rate and for setting the temperature of the mixed water to be dispensed by means of the mixing device 5b. Mixed water can be discharged via a discharge 6 having the outlet 6a at one end thereof wherein the outlet is arranged on the base body 5. Furthermore, the sanitary fitting 21 comprises an activation device 12, in particular for initiating the dispensing of minute quantities of warm water via the discharge 6. The activation device 12 can also be designed to set a delivery quantity and/or a total volume flow.

For the output of mixed water, on the one hand, the cold-water line 2 is directly connected to the mixing device 5, and on the other hand, to the central heating system having a warm-water supply 3 for the production of warm water from the cold water. In addition, the cold-water line 2 is also connected to the locally arranged boiler 4 for generating hot water from the cold water. A mixing valve 7 is arranged downstream of the warm-water supply 3, which can be used to provide cold water from the cold-water line 2 and warm water from the warm-water supply 3 mixed in one line 23. Another mixing valve 8 is arranged downstream of the line 23 to provide mixed water of the line 23 with hot water from boiler 4 in a line 234. In this case, the line 234 is connected to the outlet 6a via the mixing device 5. The boiler 4 is additionally also directly connected to the mixing device 5.

A temperature sensor 10 for measuring the temperature in the line 23 is arranged between the two mixing valves 7 and 8, and a further temperature sensor 11 is arranged in the line 234 between the mixing valve 8 and the mixing device 5. Both mixing valves 7, 8 and both temperature sensors 10, 11 are connected to a control device 9 for their control. This connection can be wired, as shown in FIG. 1, or wireless. In addition, the control device 9 may have a configuration interface (not shown) and/or a control interface for receiving further control signals 25, for instance actuation signals for switching the valves 7, 8 by means of the activation device 12 or the like.

In detail, the control device 9 can measure the temperature in the lines 23 and 234 and, depending on the temperatures present there and the warm-water tapped quantity via the outlet 6a, actuate the valves 7 and 8 accordingly to provide small tapped quantities of warm water as a mixture of cooled warm water in the lines 23 and 234 and hot water from the boiler 4. In this case, the warm-water line can be released for larger tapped quantities via an explicit release, for instance, by a user or the explicit locking of the warm-water line from the warm-water supply 3 by means of the mixing valve 7, or in the case of small withdrawal quantities by the activation device 12. The activation device 12 can have a mechanical switch/button, for instance on the sanitary fitting 21, and/or an optical detection device by means of which codes, for instance QR codes, on containers to be filled can be read and/or by means of which optical detection of the container size, for instance by means of depth measurement, can be performed. Likewise, the control device 9 can be connected to further sensors, for instance flow sensors, which are arranged in particular in the line 234 and or a clock for measuring the withdrawal period of warm water via the discharge 6a. The control device 9 can then, for instance, release the line 23 again by means of the valve 7 if a withdrawal period specified for the small withdrawal is exceeded and/or if there is such an excess or if it is predicted on the basis of a volume flow measurement and/or volume flow specification. Furthermore, a corresponding control and/or configuration can also be performed by means of an app or the like. The value of the volume flow specification can be stored in the control device 9. For the computation, the pipe length from the central warm-water supply 3, for instance a central heating system, and its diameter can be used. This volume flow specification can be set, for instance, by an installer - as mentioned above - by means of an app, a corresponding activation button, in particular by pressing it several times, by means of an adjustment wheel or by means of direct input on a touch-sensitive screen, a pushbutton or similar. A user of the sanitary fitting system can then, for instance, still select on the basis of the specifications whether
there is a house or apartment, whether
there is a warm-water tank or a combination boiler, where
the warm-water supply device is located, in particular by specifying the floor distance between the warm-water supply device and the withdrawal point, how great
the approximate distance from the withdrawal point to the warm-water supply device is, and/or how high
the warm-water temperature of the warm-water supply device should be.

By means of the activation device 12, it is also possible to provide hot water only when required by the user. The warm water in boiler 4 is then only heated up again to a presettable temperature when necessary. In other words, the heating phase in the boiler 4 is actively triggered, for instance, by pressing a button.

FIG. 2 shows steps of a method according to an embodiment of this invention.

FIG. 2 shows steps of a process for providing a fluid, in particular water. The method comprises the steps outlined below:
providing S1 warm fluid by means of a central supply device of warm fluid, preferably comprising a central heating system,
providing S2 cold fluid by means of a supply device of cold fluid for providing cold fluid,
providing S3 hot fluid by means of a local supply device of hot fluid,
   in that below a predeterminable output quantity of warm fluid and/or below a temperature at at least one point of a warm-fluid supply line from the supply device of warm fluid to an outlet, the warm fluid is provided by admixing hot fluid S4a, and above the predeterminable output quantity of warm fluid and/or temperature at at least one point of a warm-fluid supply line, the warm-fluid is provided by the central supply device of warm fluid S4b.

In summary, at least one embodiment of this invention provides at least one of the advantages listed below and/or provides at least one of the features listed below:
Simple, inexpensive manufacture.
Energy savings in the provision of warm water.
Conserving water in the use of warm water.
Higher user satisfaction.
Increase in comfort due to immediate warm-water supply

Although this invention has been described with reference to preferred exemplary embodiments, it is not limited thereto and can be modified in a variety of ways.

List of reference numerals and terms

| | |
|---|---|
| 1 | sanitary fitting system |
| 2 | cold-water line |
| 3 | warm-water tank |
| 4 | hot water tank/boiler |
| 5 | base body |
| 5 a | control lever mixing water |
| 5 b | mixing device |
| 6 | discharge |
| 6 a | outlet |
| 7 | switching valve |
| 8 | switching valve |
| 9 | control device |
| 10 | temperature sensor |
| 11 | temperature sensor |
| 12 | activation device |
| 20 | supply device |
| 21 | sanitary fitting |
| 23 | line |
| 25 | control interface |
| 234 | line |
| S1-S4a | Steps of a Method |

What is claimed is:

1. A device for providing a fluid, in particular water, comprising a central supply device of warm fluid, preferably comprising a central heating system, for providing warm fluid,
a supply device of cold fluid for supplying cold fluid,
a local supply device of hot fluid,
characterized in that
a control device is arranged, which is designed to control the devices in such a way that below a warm fluid output quantity and/or below a temperature at at least one point of a warm-fluid supply line from the supply device of warm fluid to an outlet, the warm fluid is provided by admixing hot fluid, and above the pre-determinable warm fluid tapped quantity and/or temperature at at least one point of a warm fluid supply line, the warm fluid is provided by the central warm-fluid-supply device.

2. The device according to claim 1, characterized in that a desired quantity of warm fluid can be set by means of a setting device, wherein the control device is designed to check whether the desired quantity of warm fluid is greater or lesser than the predeterminable output quantity of warm fluid.

3. The device according to claim 2, characterized in that the setting device comprises a mechanical operating element, an optical detection element and/or a radio interface for setting the desired quantity of warm fluid.

4. The device according to claim 2, characterized in that the control device and/or the setting device comprise(s) a computing device, which computes an output quantity of warm fluid on the basis of a tapping period, a measured value of a fluid volume flow and/or a predeterminable value of the fluid volume flow.

5. The device according to claim 1, characterized in that at least one temperature sensor for measuring the temperature is arranged at at least one point downstream of the supply device of warm fluid.

6. The device according to claim 1, characterized in that the warm-fluid supply line and hot-fluid supply line can be interconnected via at least one switchable valve.

7. The device according to claim 1,characterized in that the setting device comprises a user interface for actuating the heating of the supply device of hot fluid.

8. A method for providing a fluid, in particular water, comprising the steps:
providing warm fluid by means of a central supply device of warm fluid, preferably comprising a central heating system,
providing cold fluid by means of a supply device of cold fluid for providing cold fluid,
providing hot fluid by means of a local hot-fluid-supply device, characterized in that
below a predeterminable output quantity of warm fluid and/or below a temperature at at least one point of a warm-fluid supply line from the supply device of warm fluid to an outlet, the warm fluid is provided by admixing hot fluid, and above the predeterminable output quantity of warm fluid and/or temperature at at least one point of a warm-fluid supply line, the warm fluid is provided by the central supply device of warm fluid.

9. The method according to claim 8, characterized in that the predeterminable output quantity of warm fluid is set by means of a user interface and an output of the fluid is initiated.

10. The method according to claim 8, characterized in that a heating device for the supply device of hot fluid is actuated by means of a user interface.

11. The method according to claim 8, characterized in that a warm-fluid withdrawal quantity is computed on the basis of a determined magnitude of a volume flow of the discharged fluid and/or on the basis of specifications for the volume flow and/or on the basis of a withdrawal period of the discharged fluid, this is compared to the predeterminable output quantity of warm fluid, and the warm fluid is output in accordance with the comparison.

12. A sanitary fitting system), comprising
a device for providing a fluid according to claim 1,and
a sanitary fitting connected in a fluidic manner to the device for providing the fluid.
